(19) United States
(12) Patent Application Publication
(10) Pub. No.: US 2002/0000090 A1
(43) Pub. Date: Jan. 3, 2002

(54) Hybrid power station

(75) Inventor: Pertti Kari William Hoikka, Cooloongup (AU)

Correspondence Address: Marger Johnson & McCollom, P.C., 1030 S W Morrison Street, Portland, OR, 97205, US

(73) Assignee: Pertti Kari William Hoikka, Cooloongup (AU)

(21) Appl. No.: 09/894,583

(22) Filed: Jun. 28, 2001

(30) Foreign Application Priority Data
Jun. 30, 2000 (FI) 20001554

(51) Int. Cl. F16D 31/00; F16D 31/02

(52) U.S. Cl. 60/398; 60/325

(57) ABSTRACT

The invention relates to a hybrid power station, which comprises a structure (1) or building, onto which water tanks (2) and pumps have been mounted at different levels and which have been arranged such that they pump water from the lower water tank to the upper water tank, and said structure having energy collecting devices installed in its vicinity or on its outer surface, which are arranged such that they use the pumps, and said hybrid power station comprising a water tank (5) inside the structure/building, to which the pumped water is lead, and equipment (6) inside the structure, such as a turbine, for producing electrical energy. A hybrid power station formed in accordance with the invention is formed at least partially of inclined walls, and such that the inner tank is primarily formed like a cone, or truncated cone.

The invention relates to a hybrid power station, which comprises a structure or building, onto which water tanks and pumps have been mounted at different levels and which have been arranged such that they pump water from the lower water tank to the upper water tank, and said structure having energy collecting devices installed in its vicinity or on its outer surface, which are arranged such that they use the pumps, and said hybrid power station comprising a water tank inside its structure/building, to which the pumped water is lead, and equipment inside the structure, such as a turbine, for producing electrical energy.

Hydropower stations, among other types of power stations, are used for producing electrical energy. In hydropower stations, water is lead through a turbine, or other corresponding device, the water turns the blades of the turbine and the produced energy is converted into electrical energy. Typical hydropower stations are located by a river or corresponding waterway, where the difference in elevation can be taken advantage of to move the water downwards and produce energy.

Tanks or reservoirs located out in the open terrain, or corresponding area, are also used for producing energy; water is pumped to the reservoir from a waterway, reservoir, or corresponding water source, on a lower elevation during the inexpensive energy consumption periods. Water is lead downwards through the turbines, or corresponding devices, to produce energy during the expensive energy periods. Thus, compensating for and taking into account the peaks of energy consumption. In these solutions, electrical energy is used to pump the pumps, and electrical energy is produced in the conventional way.

A certain problem with the current systems is that they require the production of external energy, A further disadvantage is that the difference in price between the energy produced during expensive periods and energy produced during inexpensive periods is not great enough to make such a system profitable. In the German patent publication 3,640,470, an ecological power station is presented, in which water is pumped to a tank by the use of wind or solar energy. However, the structure of the equipment in this publication is not described well enough.

The object of the invention is to provide a power station, which, in addition to making use of water, also takes advantage of other environmental energy sources. Additionally, the object of the invention is to provide a hybrid power station, which operates on its own power, is easy to use and reliable. Furthermore, the object of the invention is to provide a hybrid power station, which is self-sustaining and profitable to operate.

The object of the invention is accomplished with a hybrid power station, the characteristics of which are set forth in the claims.

A hybrid power station formed in accordance with the invention is formed from walls, which are at least partially inclined, such that the inner water tank is formed like a cone, or a truncated cone. Thus, the space within the structure/building is best utilized. Different residences, apartments, hotel rooms, office spaces or other corresponding spaces can be constructed on the edge parts of the structure. The hybrid power station can also be used, for example, as a maritime hotel, spa, emergency aid location, hospital, or luxury apartments.

When in operation, the hybrid power station pumps pump water from the water tank on the lower level up to the higher water tank. The energy necessary for the pumps is obtained from natural, unpolluted energy sources, such as wind power stations, solar energy panels, or corresponding sources, or other means of harnessing natural sources of energy. From the uppermost water tank, or possibly also from one or several lower water tanks, the water is lead to the water tank inside the structure/building. The base or side of the structure/building has one or more turbines, or corresponding equipment, appropriately placed, through which water is lead. Water causes the turbines to rotate as it passes through them, and thus the produced electricity is lead to the desired location.

The outward appearance of the structure/building of the hybrid power station can alternatively be an inclined and smooth-leveled wall surface, or formed in steps. The hybrid power station itself can be produced from material suitable for the purpose. A certain alternative is to construct a hybrid power station in a shipyard from steel and concrete and steel cables with a base.

The hybrid power station is placed in the desired location. The best location to set up a hybrid power station, is on an underwater rock, islet or in shallow water, which requires leveling and drilling holes into the foundation for bolts. The hybrid power station can also be located in the vicinity of a waterway, such as a river. One alternative is to build a hybrid power station along the shore, because it would not be necessary to make roads or bridges. This hybrid power station is also well-suited for ground which may potentially become submerged under water.

In one advantageous application of the invention, a hybrid power station comprises a separate base with a frame, If necessary, a separate base and separate frame structure can be towed, for example, as an ocean-going tow-load to the destination.

In a further application of the invention, turbines are adjustably connected to the water tank in a vertical direction. Thus, the position of the turbines can be changed as needed.

In a certain application, the structure/building is formed as a pyramid. In this application, the smooth-surfaced sides of the pyramid are lined at least partially with solar panels, or corresponding devices used to contain solar energy. Accordingly, wind power stations are mounted in the corners of the sides. The size of the panels and wind power station can vary in different applications, such that the best possible use of the wind and solar energy is striven for. The cardinal points on the compass and prevailing wind conditions are also taken into consideration as best as possible when placing the structure/building and equipment.

Solar panels do not necessarily need to be mounted to the walls. The solar panels can, for example, be convex and installed on steel masts, whereupon they can be turned towards the sun. These are more suitable for step-structure models.

In another certain application of the invention, the structure/building is formed like a truncated pyramid. Thus, different buildings, structures, or corresponding constructions can be added on the top of the structure/building in the desired way.

The size of the structure/building of a hybrid power station formed in accordance with the invention can vary as desired and it can be several tens or hundreds of meters in height. Its maximum height depends on how much strain the foundation can withstand. The structure/building can have different sizes in different applications. The number of the structure's/building's sides can vary in different applications. In some application, the inclination of the structure's/building's sides can vary from one another, whereupon local conditions can better be taken into consideration. Solar panels or other energyharnessing devices are naturally mounted on the side, or sides, where the sun is shining, or other energy source is mostly concentrated.

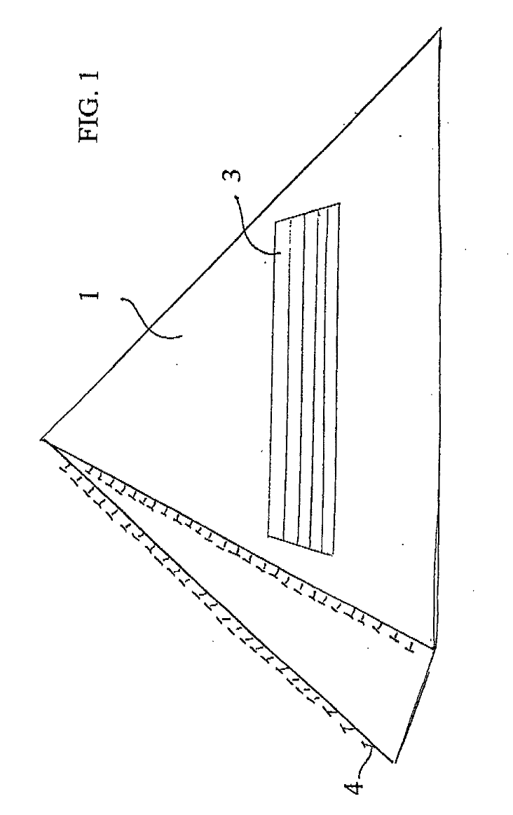

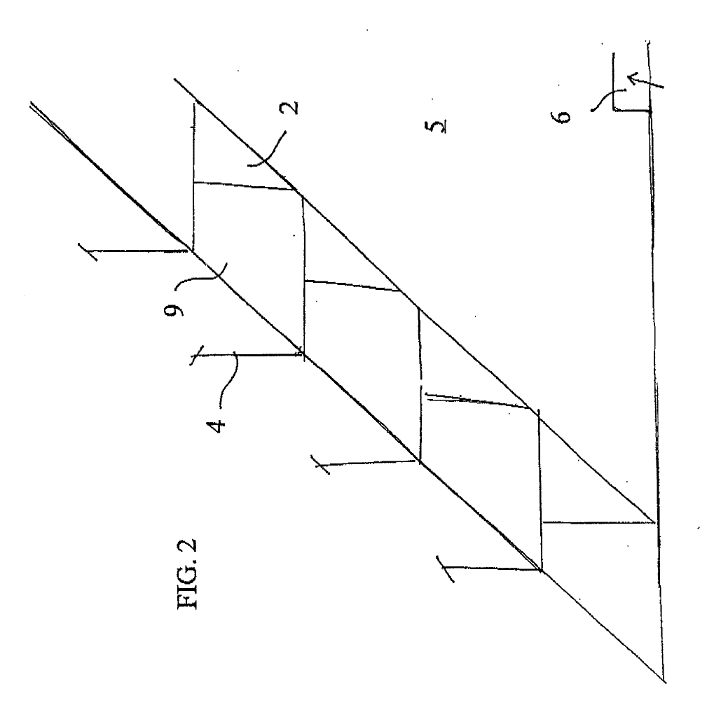

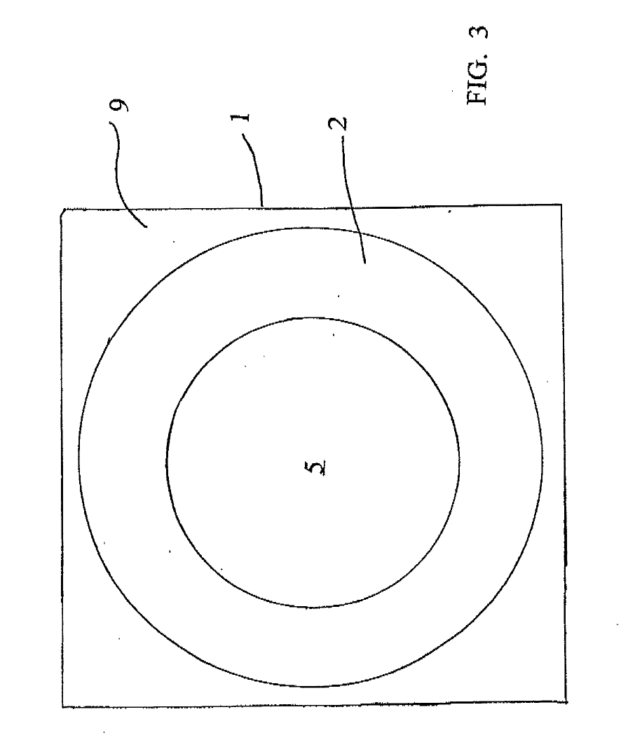

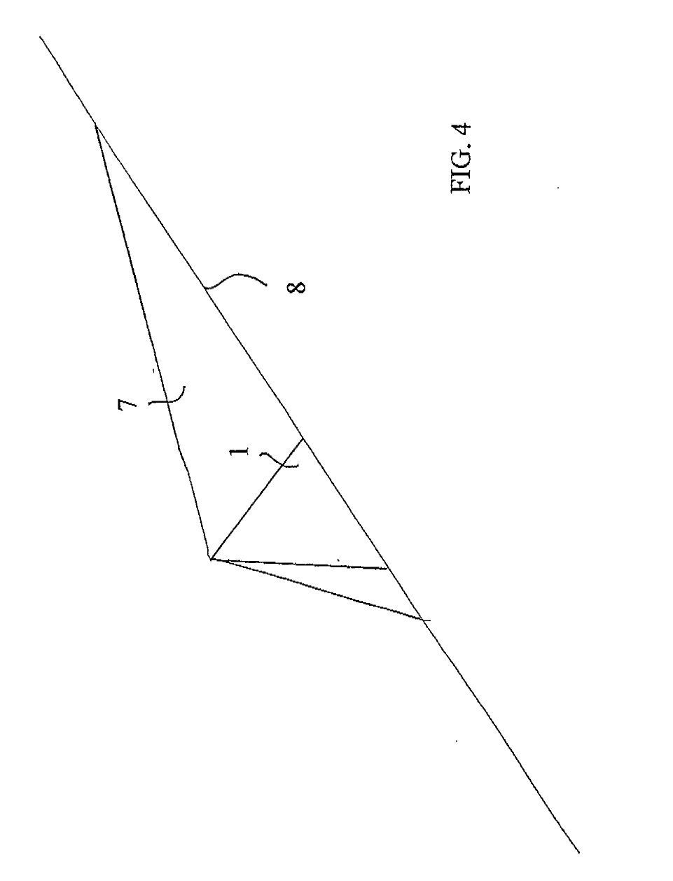

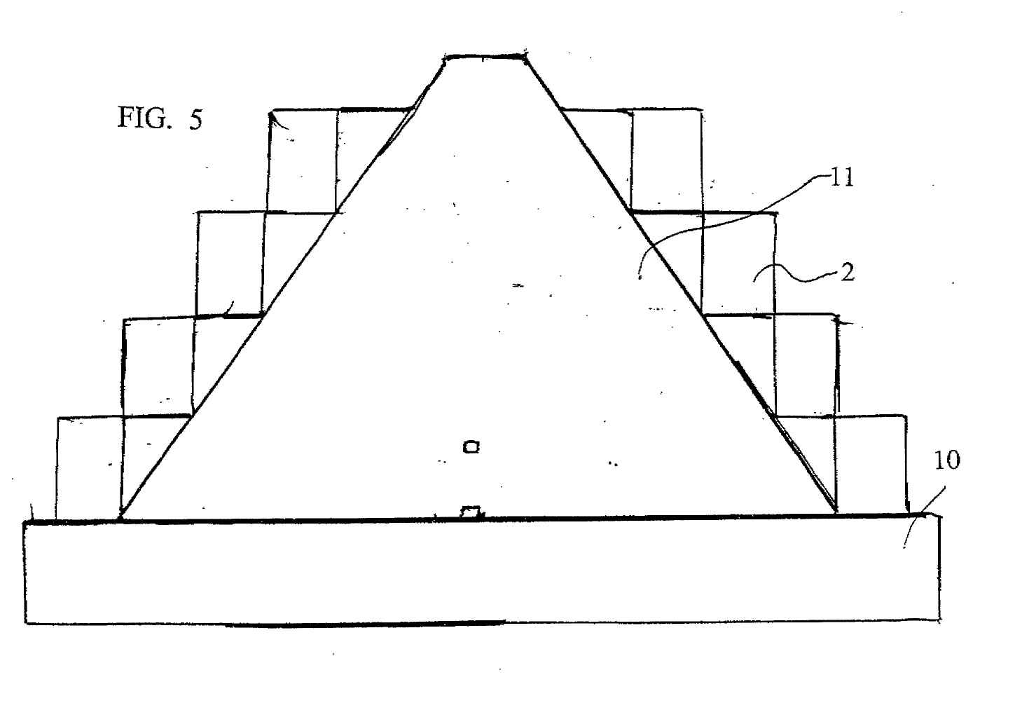

The invention will now be described in more detail with reference to the accompanying drawings, in which FIG. 1 illustrates a certain application of a structure formed in accordance with the invention, as viewed from the side, FIG. 2 illustrates a partial cross-section of the side part of a structure formed according to FIG. 1, FIG. 3 illustrates a cross-section of a structure formed according to FIG. 1, some distance above the base, FIG. 4 illustrates a certain application of a certain other structure formed in accordance with the invention, located on open terrain, and FIG. 5 illustrates a cross-section of a structure formed in accordance with the invention.

The structures l formed according to FIGS. 1-4, have been formed as fourcornered pyramids. Structures/buildings in other applications can be different. In these applications, many solar panels 3, or corresponding devices for collecting solar energy, have been installed on the sides of the pyramids, which face the sun. The number of solar panels varies in different applications. In the corners between the sides, several wind rotors 4 have been placed at a distance from one another, the blades of which are turned by the air current rising upward along the wall of the structure. The wind rotors and sun panels are connected to an electricity accumulator.

According to FIG. 2, several separate water tanks 2 are placed on the inside of the sides of the structure, such that they are at different elevations on the sides of the structure. An empty space 9 is left between the water tanks and the side of the structure, which can be used, if desired, for example, for commercial purposes or in some other way. Pumps (not shown) are also mounted to the structure, by which water is pumped from the lower tank to the upper tanks. These pumps are powered by the wind generators and solar panels, or the electricity accumulators that they are connected to. It is also possible to use the pumps with other power sources, such as, for example, the turbine presented below.

The water tanks 2 are mounted one on top of the other, such that the uppermost water tank, or water tanks, which can be emptied into the large water tank 5 inside the structure, are near the top of the structure. In this application, the water tank 5 inside of the structure is cone-shaped, but the shape of the tank can vary in the desired way in other applications. On the bottom of the water tank 5 is one or more turbines 6, or corresponding device for producing electrical energy. These devices can be on the side of the structure in some applications. In other applications, the turbines are mounted to the support equipment, whereby they can be moved in a vertical direction. This is especially for floods. Additionally, a reserve turbine (not shown) can be in the water tank. The turbines are economical and built for this purpose. They operate under great amounts of water pressure, for example, under 100 meters of water.

A structure/building formed in accordance with the invention is located near the water or on the water. Water can be taken for the structure/building from any water body, such as a river, lake, pond, the sea, or other water source. Water is pumped with the pumps from one water tank to another, from the lower level, to the upper level, from which the water is lead to the large water tank inside. From this water tank, the water is lead through the turbines out of the structure. When the water is lead through the turbines, the water turns the turbines and the produced electrical energy is utilized and transferred to the desired destination. The used water is lead back to the water source from which it was taken. It can alternatively be lead somewhere else, for example, the water can be pumped to the desired place for irrigation. Thus, it is possible to arrange for a water outlet on a level somewhat higher than surrounding ground level, so that the water can be lead into the environment in the desired way.

In the application presented in FIG. 4, the water is lead through a special channel 7 from a point upstream and at a higher elevation in a river 8 directly to the upper part of the structure 1, where it is led into a tank. Thus, the water coming from this channel 7 does not need to be separately pumped upwards first.

In the application presented in FIG. 5, the tanks 2 on the side of the main, truncated, cone-like water tank from which water is pumped upwards, are vertical and progress step-wise upwards along the full length of the cone. The hybrid power station has a separate base 10 and frame part 11 attached to it.

A complete hybrid power station produces electricity independently, without other energy sources. It is also possible to fill the main water tank at first mechanically, such that great pressure is exerted on the turbines. In the new cross-sectional drawing of the step-hybrid power station, the dimensions are not correct, rather, the apartments are not joined to the tanks and height measurements take into account the delivery height of the pumps.

The invention is not limited to the advantageous applications presented herein. Its form may vary within the frames of the concept of the invention set forth in the claims.

Throughout the specification, unless the context requires otherwise, the word “comprise” or variations such as “comprises” or “comprising”, will be understood to imply the inclusion of a stated integer or group of integers but not the exclusion of any other integer or group of integers.

1. A hybrid power station comprising a structure or building, onto which water tanks and pumps have been mounted at different levels and which have been arranged such that they pump water from the lower water tank to the upper water tank, and said structure having energy collecting devices installed in its vicinity or on its outer surface, which are arranged such that they use the pumps, and said hybrid power station comprising a water tank inside its structure or building, to which the pumped water is led, and equipment inside the structure, such as a turbine, for producing electrical energy, wherein the hybrid power station is formed at least partially of inclined walls, and the inner tank is primarily formed like a cone, or truncated cone.

2. A hybrid power station according to claim 1, wherein the hybrid power station further comprises a separate base and a frame part which can be attached thereto.

3. A hybrid power station according to claim 1 wherein the turbines are adjustably connected in a vertical direction to the water tank.

4. A hybrid power station according to claim 2 wherein the turbines are adjustably connected in a vertical direction to the water tank.
